(19) United States
(12) Patent Application Publication
(10) Pub. No.: US 2009/0132337 A1
(43) Pub. Date: May 21, 2009

(54) METHOD AND SYSTEM FOR IMPROVEMENTS IN OR RELATING TO THE PROVISION OF PERSONALIZED THERAPY

(75) Inventor: Peter KEELING, Belfast (GB)

Correspondence Address: FOLEY AND LARDNER LLP;SUITE 500, 3000 K STREET NW, WASHINGTON, DC, 20007, US

(73) Assignee: Diaceutics

(21) Appl. No.: 11/943,534

(22) Filed: Nov. 20, 2007

(51) Int. Cl. G06F 17/30

(52) U.S. Cl. 705/10

(57) ABSTRACT

A method of comparing a first brand with one or more second brands by identifying a differentiation factor between the first and second brands, the method comprising the following steps. The first step entails identifying a plurality of elements which can differentiate between one brand and another. Secondly, a consensus score is determined with respect to the first brand and the or each second brand based on the plurality of elements. Next, the consensus score of the first brand is compared with the or each second brand in order to identify elements for which the first brand has a substantially equal or higher score than the or each second brand. Finally, the identified elements for which the first brand has a substantially equal or higher score than the or each second brand are displayed in a visual manner to enable identification of key marketing criteria which can position the first brand relative to the or each second brand.

### FIELD OF THE INVENTION

The present invention relates to improvements in or relating to the provision of a personalized therapy or medical service. In particular, the invention relates to an improved method and apparatus for enabling such services.

### BACKGROUND OF THE INVENTION

The pharmaceutical and diagnostic industries have occupied the same market place for many years. However, the two industries have evolved in very different ways using two very different business models. These different business models are culturally and financially distinct. When the two are required to work together the result is often suboptimal in terms of the results they generate, both with respect to clinical and business solutions.

In the past, a patient was diagnosed and then treated in separate parts of the same system. The distinct identities of diagnosis and therapeutics have coexisted to provide an overall continuum of care to the patient. There has been occasional collaboration between diagnostic and therapeutic systems but generally the two have operated without substantial collaboration.

One present emphasis is now on personalized medicine in key therapeutics areas. In particular, these may relate to a therapy targeted by a novel molecular diagnosis. As a result it will become and is becoming critical to integrate the pharmaceutical and diagnostic business model in order that the two can cooperate.

The advent of personalized medicine requires parallel development of a diagnostic; and diagnostic market or franchise to enable doctors to choose and monitor specific therapies. The efficiency of this interdependency will in turn rely on the ability of each industry to understand the drivers of the other. This would then enable the industries to find new ways to partner around the same clinical proposition in a mutually beneficial way.

As consequence of this there is a need to understand how personalized therapy aids the marketing, positioning and competitive dynamics of an individual therapy brand. In order to do this, the marketing of personalized therapy will need to be changed in order to optimize timescales and benefits for both the pharmaceutical and diagnostic business models.

### SUMMARY OF THE PRESENT INVENTION

One object of the present invention is to provide a method and apparatus which overcomes at least some of the problems associated with the prior art.

Another object of the present invention is to provide a means of identifying the comparative brand equity between a therapy personalized by a diagnostic and a therapy which is not.

According to one aspect of the present invention there is provided a method of comparing a first brand with one or more second brands by identifying a differentiation factor between the first and second brands, the method comprising the steps of identifying a plurality of elements which can differentiate between one brand and another with respect to the one or more marketing factor; determining a consensus score with respect to the first brand and the or each second brand based on the plurality of elements; comparing the consensus score of the first brand with the or each second brand in order to identify elements for which the first brand has a substantially equal or higher score than the or each second brand; displaying the identified elements for which the first brand has a substantially equal or higher score than the or each second brand in a visual manner to enable identification of key marketing criteria which can position the first brand relative to the or each second brand.

An advantage of this invention is that it defines the additional brand equity dynamics (elements) advantages which a personalized therapy has over a “one size fits all” non personalized therapy.

In addition, the invention provides a means by which a pharmaceutical team can “position” their therapy or brand versus other competition in the same market place. The invention further goes on to assist with the understanding of the specific brand elements within which this competitive positioning can be created. A consensus is created across multi functional teams from R&D and marketing in respect of these elements. The invention also assists in the briefing of market research and advertising agencies tasked with converting therapy positioning into editorial copy acceptable to pharmaceutical company customers.

### BRIEF DESCRIPTION OF THE DRAWINGS

Reference will now be made, by way of example, to the accompanying drawings, in which:—

FIG. 1 is a flow chart of the method steps associated with one of the basic steps in the overall method, in accordance with one aspect of the present invention, by way of example.

FIG. 2 is a table demonstrating differential branding elements and essence or associated therewith as derived from the method of FIG. 1, in accordance with one aspect of the present invention, by way of example.

FIG. 3 is a flow chart of the method steps associated with one of the basic steps in the overall method, in accordance with one aspect of the present invention, by way of example.

FIG. 4 is a graph identifying the visual, spatial and quantitative output from the FIG. 2 table.

FIG. 5 is a flow chart of the method steps associated with one of the basic steps in the overall method, in accordance with one aspect of the present invention, by way of example.

FIGS. 6a, 6b and 6c are a set of drawings identifying the positioning conceptualization of the branding elements.

### DETAILED DESCRIPTION OF EMBODIMENTS OF THE PRESENT INVENTION

At a high level the basic method in accordance with the present invention is made up of three steps. These steps are a consensus scoring step; a visualization and quantification step and a positioning conceptualization step. Each of these steps will be described in greater detail below.

The consensus scoring step allows cross functional teams to compare one or more direct competitors for a particular therapy or brand and score on a simple index across different criteria. The different criteria are referred to as differential positioning elements.

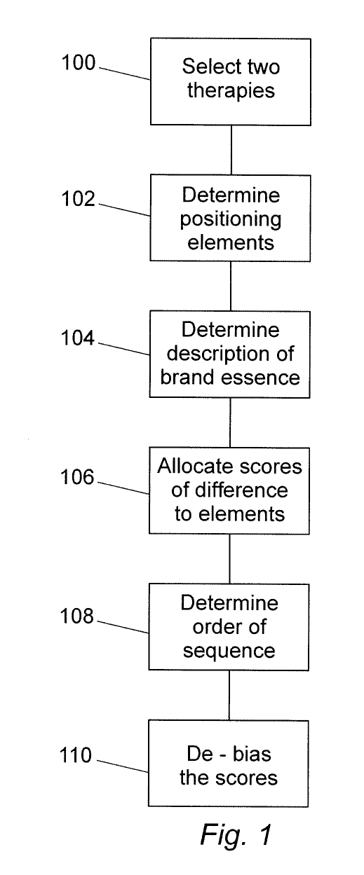

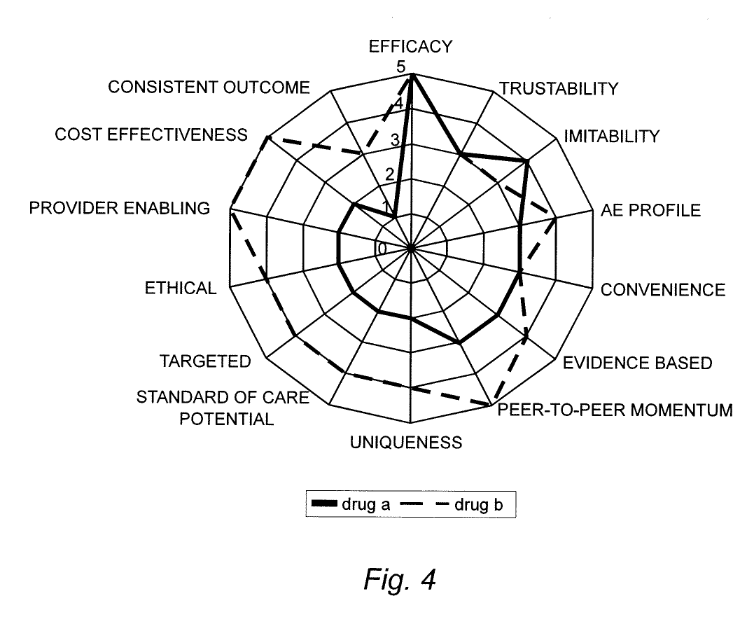

Referring now to FIG. 1 the steps of the consensus scoring process are described. At step 100 two or more therapies are selected for the differential comparison. A set of positioning elements are determined at a 102. In this case there are 14 positioning elements which are based on the potential descriptors which differentiate therapies in the same therapeutic areas. At 104 a description of brand essence is determined for each of the elements identified in step 102. These simplified descriptions are used to assist understanding for cross functional and non-marketing trained teams. At step 106 a simple one to five scoring index is identified. This is used to apply the numerical indicator to the 5 degrees of difference between each of the elements identified above. At step 108 the order of sequence of consideration of each element is determined. The order of sequence is an important criterion for many reasons. One reason is the fact that the area of greatest difference between the brands (which may be an area created over 4-5 elements which scored higher than the competitor brand) may be identified. The data sorting is designed to “bunch” lower scores for the competitor product and match these where possible to higher scores for the Personalized drug. In this way, FIG. 4 is much easier to interpret and display spatially where the advantages and disadvantages are. This will be described in greater detail below. If the data sorting in this way did not occur the spider diagram of FIG. 4 would look like a series of discrete spikes and would fail to demonstrate visually the difference between the two drugs. Next at step 110 the elements are presented in conjunction with, for example, so called “traditional differential elements used in therapy positioning”. These traditional elements are efficacy, safety, convenience and cost effectiveness. With the additional 10 new elements identified in the described example and enabled by the advent of personalized therapy, a clear understanding of the differential importance of the therapy, drug or brand is determined. By using (in this example) 14 elements, any bias brought about by the effects of a particular element tend to be ameliorated.

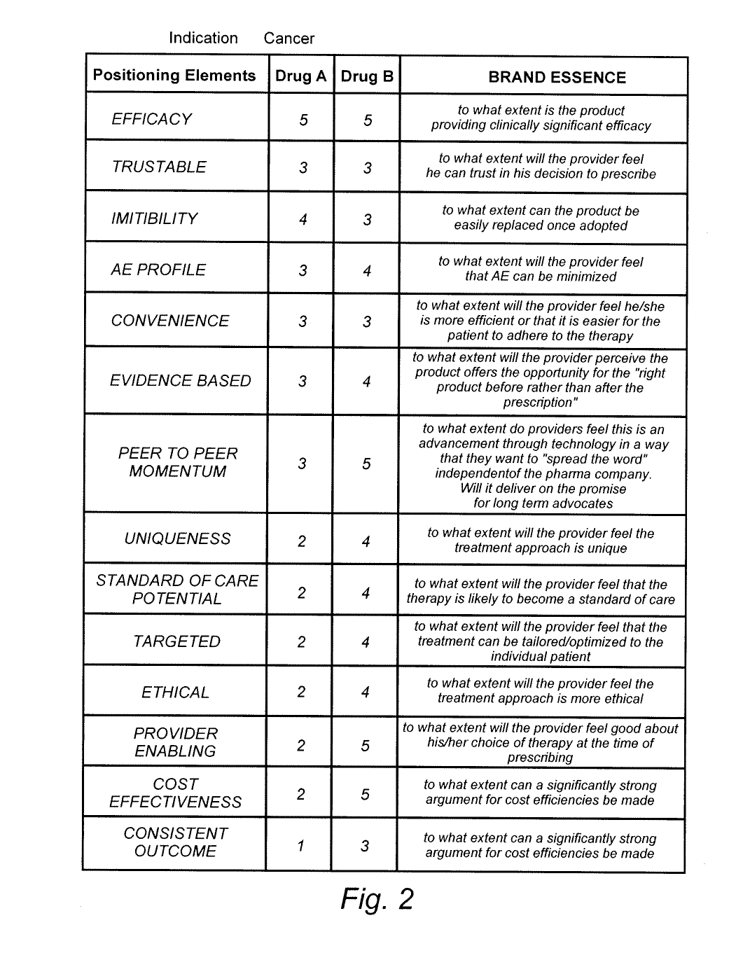

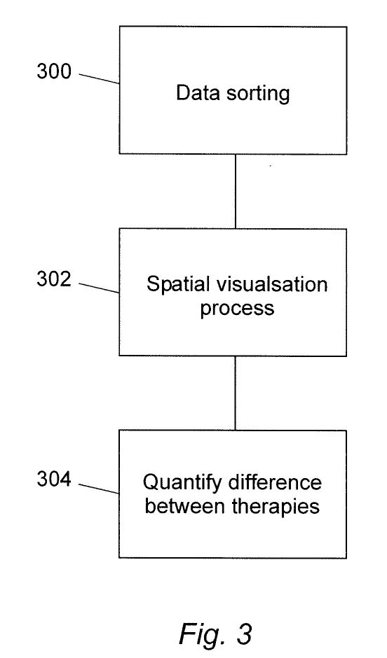

FIG. 2 shows a table of the different positioning elements (herein referred to as elements) including a score for a drug A and a drug B and an indication of the brand essence for each of the positioning elements. The first element is efficacy which has a brand essence which indicates to what extent the product provides clinically significant efficacy. The second element is trustability which gives a brand essence indicator of the extent to which the provider can trust a decision to prescribe the particular drug or brand. The third element is imitability, which has a brand essence indicator of the extent the product can be replaced once adopted. The adverse event (AE) or side effect profile element has a brand essence indicator to the extent to which the provider can minimize AE. For the convenience element the brand essence relates to the efficiency and ease with which a patient can adhere to the therapy. For the evidence based positioning elements the brand essence relates to the perception that the drug offers an opportunity for the right product rather than the prescription.

The peer-to-peer momentum positioning elements has a brand essence that relates to the advancement through technology in the way the “word is spread” independent of the pharma company that is producing that particular drug. The uniqueness element has a brand essence which relates to the extent that the treatment approach is felt to be unique. The standard of care potential element has a brand essence relating to the extent to which the therapy is likely to become a standard of care. The targeted element has a brand essence relating to the extent to which the treatment can be tailored or optimized for a particular patient. The ethical positioning element has a brand essence relating to the extent to which the treatment approach is more ethical than another. The provider enabling positioning element has a brand essence relating to the extent to which the choice of therapy “feels good” at the time of being prescribed. The cost effectiveness positioning elements has a brand essence relating to the extent to which an argument for cost efficiency can be made. The consistent outcome positioning element has a brand essence which relates to the extent to which a test will give a consistent answer for each unique patient. As can be seen for drug A and drug B, a score is indicated for each element. The effect of this score and how it is determined are both described below.

Referring now to FIG. 4, which is a spider diagram which represents the differences between the two drugs in a spatial manner. This assists in the explanation description and communication that one drug has a different brand equity footprint than the other. For example, both perform in the same manner with respect to Efficacy and Trustability but very differently with respect to Cost Effectiveness and provider enablement. The spider diagram gives an indication of the brand equity footprint, which in turn gives an indication of which of drugs A and B are the “best”.

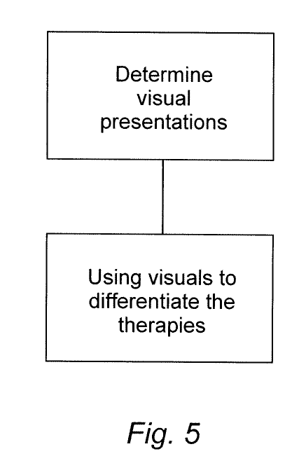

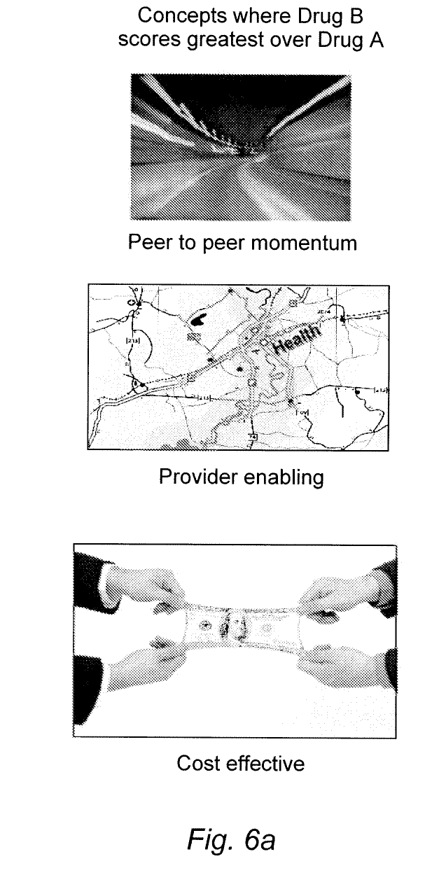

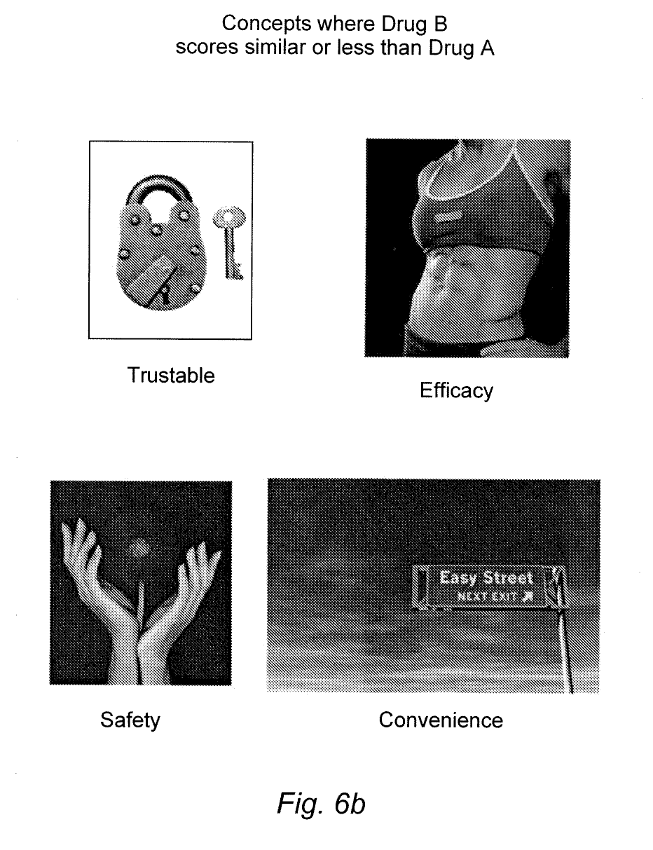

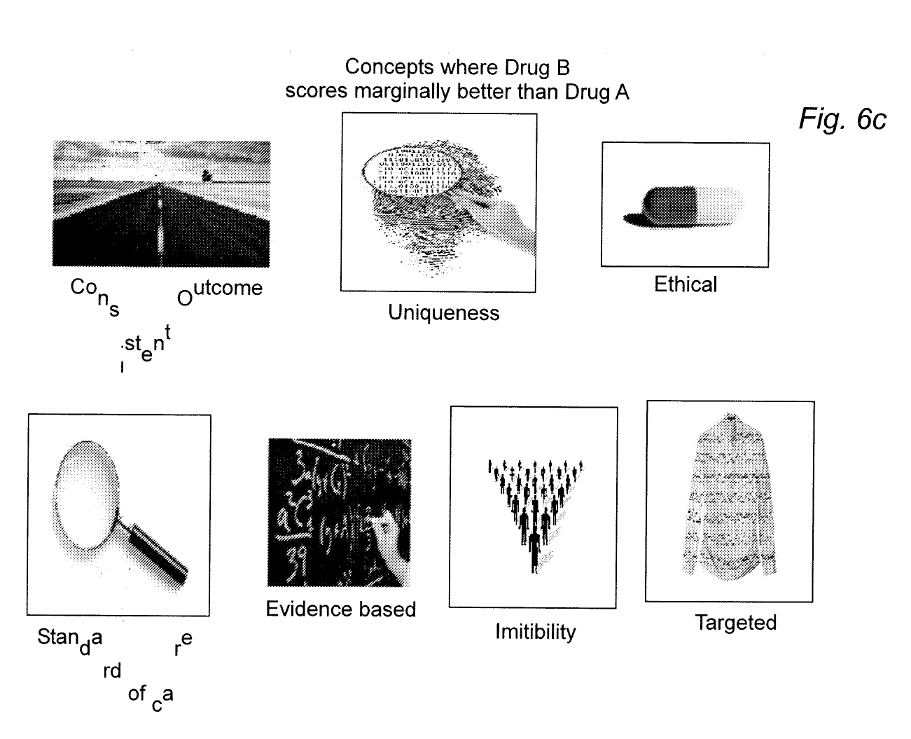

FIG. 5 is a flow chart demonstrating the positioning conceptualization step. In this element of the invention a number of visual representations are determined to demonstrate the elements mentioned above. These can then be viewed for each of the two drugs (one marketed with a test and one without, in the present example) to demonstrate the value of marketing with a test where appropriate. The results are shown in FIGS. 6a, 6b and 6c. In FIG. 6a the elements/concepts where drug B scores greater than drug A are identified. Drug A is a known drug co-marketed with a test and drug B is the drug being evaluated in accordance with the present invention. The element where drug B scores more than drug A in the present invention includes peer-to-peer momentum, costs effectiveness and provider enabling. FIG. 6b shows the elements where drug B and drug A are substantially similar. These include trustability, efficacy, convenience and safety. FIG. 6c shows the elements where drug B scores slightly better than drug A and include consistent outcome, uniqueness, ethicality, standard of care, evidence-based, imitability, and targeting.

The method may then be incorporated within a planning program, to underpin the process and above mentioned steps. An example of such a planning program is disclosed in U.S. Ser. No. 11/625,242, incorporated herein by reference.

It will be appreciated that the essential framework of this method gives a number of key advantages over prior art systems and current methodologies. In addition, the ability to differentiate between personalized therapies can create consensus on positioning and enable external briefings of marketing and sales teams.

It would be obvious that the above described invention may be varying in many ways. For example the method may make use of more or less elements, considered in the context of the two or more drugs, for example to determine which is better than the other with respect to these elements. Similarly, the method need not be limited to determining whether or not a drug should be sold with a test. Other marketing factors may be used instead, for example determining whether or not a drug should be sold with advertising, governmental approvals, or any other appropriate diagnostic. Similarly, the invention does not need to be limited to drug sales, marketing and position, but can instead include other types of brand where a number of elements and marketing factors may influence the sales marketing and position of the brand. Any such variations are not to be regarded as a departure from the scope of the invention and as such all such modifications are intended to be included within the scope of the invention.

1. A method of comparing a first brand with one or more second brands by identifying a differentiation factor between the first and second brands, the method comprising the steps:
identifying a plurality of elements which can differentiate between one brand and another;
determining a consensus score with respect to the first brand and the or each second brand based on the plurality of elements;
comparing the consensus score of the first brand with the or each second brand in order to identify elements for which the first brand has a substantially equal or higher score than the or each second brand;
displaying the identified elements for which the first brand has a substantially equal or higher score than the or each second brand in a visual manner to enable identification of key marketing criteria which can position the first brand relative to the or each second brand.

2. A method as claimed in claim 1, wherein the step of identifying the plurality of elements comprises determining an element with an associated brand essence which is capable of differentiating one brand from another in a particular market area.

3. A method as claimed in claim 1, wherein the step of determining a consensus score comprises: determining any differential score between the first brand and the or each the second brand for each of the plurality of elements.

4. A method as claimed in claim 1, wherein the step of comparing the consensus score of the first brand with the or each second brand is based on a graphical representation of the scores for each brand.

5. A method as claimed in claim 1, the step of displaying the identified elements comprises identifying a marketing image associated with the element, which can be used in association with the first brand to demonstrate its advantages.

6. A method as claimed in claim 1, further comprising selecting the plurality of elements from the group containing: efficacy, trustability, imitability, AE profile, convenience, evidence-based, peer-to-peer momentum, uniqueness, standard of care potential, targeted, ethical, provider enabling, cost effectiveness, consistent outcome.

7. A method as claimed in claim 1, further comprising determining a marketing factor appropriate to the first brand.

8. A computer program comprising instructions for carrying out the method according to claims 1, when said computer program is executed on a computer system.
